(19) United States
(12) Patent Application Publication
(10) Pub. No.: US 2011/0250409 A1
(43) Pub. Date: Oct. 13, 2011

(54) MULTIFUNCTIONAL, RESPONSIVE FUNCTIONAL LAYERS ON SOLID SURFACES AND METHOD FOR THE PRODUCTION THEREOF

(75) Inventors: Oliver Marte, Wattwil (CH); Martin Meyer, Thalwil (CH); Murray Height, Zurich (CH)

(73) Assignee: HeiQ mATERIALS ag, Bad Zurzach (CH)

(21) Appl. No.: 13/054,357

(22) PCT Filed: Jul. 13, 2009
(86) PCT No.: PCT/CH2009/000249

§ 371 Date: Jun. 24, 2011

(30) Foreign Application Priority Data
Jul. 15, 2008 (CH) 1096/08
Jul. 7, 2009 (CH) 1047/09

(51) Int. Cl. B32B 5/02; B05D 3/02; D06M 15/19; A41D 13/00; A41D 1/00; A41B 9/00; B32B 3/10; B05D 1/00

(52) U.S. Cl. 428/195.1; 442/59; 427/372.2; 427/209; 2/455; 2/69; 2/400; 252/8.61; 252/8.62

(57) ABSTRACT

A multifunctional, responsive functional layer on a substrate, such as textiles, paper and plastic materials, includes at least one first and a second functional component, of which at least one of the second functional components meets the chemical-functional and constitutional specification for responsive behavior and thereby can be reversibly switched by an outer stimulus. The first and second functional components differ with respect to the intrinsically specified properties thereof and are matched to each other, wherein at least one of the functional components on the substrate is present as a physical-chemical compound. Methods are disclosed for producing the multifunctional, responsive functional layer, which enable the combination of functions, such as moisture management, soil release, antistatic, hydrophobicity, hydrophilicity, oleophobicity, controlled release, and conductivity.

The invention relates to multifunctional, responsive functional layers on solid surfaces according to Claim 1 and the method for the production of the same according to Claims 18 to 20.

The production of multifunctional layers on solid matrices, as represented by textile, paper and plastic materials, has gained enormous importance and is the subject of current research and development projects. Various combined functional examples, such as, e.g., flame-retardant and dirt-shedding or drip-dry and anti-static, etc., are already used in practice and are also described in technical literature [1].

The list below consolidates the documents based on which the prior art is subsequently explained:
[1] S. Duquesne et al., Multifunctional Barriers for Flexible Structure, (2007), pp. 39-43, 63-71, 109-124, Springer Berlin, Heidelberg, New York
[2] http://en.wikipedia.org/wiki/Phase_Change_Material
[3] St. Galler Tagblatt, Friday, Jun. 6, 2008
[4] V. Papaefthimiou, R. Steitz, G. H. Findenegg, Responsive Polymerschichten [Responsive Polymer Layers], Chem. Unserer Zeit [Chem. Of Our Time], (2008) 42, pp. 102-115
[5] J. Rühe, M. Ballauf, M. Biesalski et al., Polyelectrolyte Brushes, Adv. Polym. Sci (2004) 165, pp. 79-150
[6] M. Motornov, R. Sheparovych et al., Stimuli-Responsive Colloidal Systems from Mixed Brush-Coated Nanoparticles, Advanced Functional Materials (2007) 17, pp. 2307-2314
[7] D. Hegemann, M. M. Hossain, D. J. Balazs, Nanostructured Plasma Coatings to Obtain Multifunctional Textile Surfaces, Progress in Organic Coatings 58 (2007), pp. 237-240
[8] M. Weder, A. Satir, W. Federer, Wenn sich die Kleidung dem Menschen anpasst [When the Clothes Fit the Man], Eidgenössische Materialprüffungs- und Forschungsanstalt [Federal Materials Testing and Research Station], Media Information, Dübendorf, September (2002)
[9] W. D. Schindler, P. J. Hauser, Chemical Finishing of Textiles, CRC Press (2004), pp. 87-96, Boca Raton, Boston, New York, Washington, D.C.
[10] F. D. Evans, H. Wennerström, The Colloidal Domain, Wiley-VCH (1999), pp. 606-608 New York
[11] H. Mollet, A. Grubenmann, Formulierungstechnik [Formulation Technique], pp. 47-55, Wiley-VCH Verlag (2000) Weinheim, New York
[12] M. Tanaka, E. Sackmann, Polymer-Supported Membranes as Models of the Cell Surface, Nature (2005) 437, pp. 656-663
[13] A. Janshoff, C. Steinem, Transport Across Artificial Membranes, An Analytical Perspective, Anal. Bio. Chem. (2006) 385, pp. 33-51
[14] R. v. Klitzing, Internal Structure of Polyelectrolyte Multilayers Assemblies, Phys. Chem. Chem. Phys. (2006) 8, pp. 5012-5033
[15] K. Glinel, C. Dejugnat, M. Prevot et al., Responsive Polyelectrolyte Multilayers, Colloid Surf. A. (2007) 303, pp. 3-13
[16] C. Wu, S. Zhou, First Observation of the Molton Globule State of a Single Homopolymer Chain, Phys. Rev. Lett. (1996) 77, pp. 3053-3055
[17] W. Barthlott, C. Neinhuis, Nur was rauh ist, wird von selbst sauber [Only That Which Is Rough Is Clean by Itself], Technische Rundschau [Technical Review] No. 10, (1999), pp. 56-57
[18] L. Feng et al., Petal Effect: A Superhydrophobic State with High Adhesive Force, Langmuir Vol. 24, (2008), pp. 4114-4119

The examples that are mentioned in Document [1], effects achieved by a finishing or coating, are permanently present. When using phase-change materials [2] (e.g., Micronal® PCM of the BASF Company) in multifunctional layers, the heat-regulating effect that is triggered by these materials is reversible. The phase-change materials are microcapsules whose contents are, e.g., an electrolyte or electrolyte mixture or low-melting polymers. During the phase change (solid/liquid or liquid/solid), heat is received or released, by which a temperature regulation is possible by the finish produced with phase-change materials. In the most recent works [3], e.g., protective blankets for horses are examined, which are both highly reflective and contain phase-change materials in the coating.

In the literature, additional polymer materials are described—so-called responsive polymer materials that can be reversibly switched on and off by an external stimulus—but not their use in multifunctional layers [4], [5], [6].

The production principle of multifunctional layers on textiles used today in most cases consists in mixing at least two functional products or composites in an application liquor or in the sequential application of the functional products on the substrate to be treated. Below, the term substrate is also used as a representative of various solid matrices such as, e.g., textile, paper and plastic or synthetic fiber materials.

Known production methods of multifunctional layers, according to one of the above-mentioned principles, are described in the following documents:

a) Functional finishes with a one-stage procedure [1]:

Anti-static, water-, oil- and dirt-shedding, flame-retardant, drip-dry, etc.

b) Sequential application of functional layers (two-stage procedure):

‘Textile Surface’ (WO 02/075038 A2).

Plasma technology [1], [7] offers another, very current technology for the production of multifunctional layers.

Two combined functions preferably desired today are humidity and heat regulation on human skin by clothing and the finish thereof. These functions were intensively researched and discussed [8] for the last ten years. For this purpose, functional models have been developed and produced for various applications that use many different resources from fiber material to fabric design to manufacturing technology.

Another noteworthy dual function is contained in the term ‘soil release’ [9], wherein both dirt shedding and the ability to wash the sorbed dirt out again are required as functions.

Another multifunctional layer that is desired primarily for worker-safety clothing and bed linens in the health-care field encompasses dirt shedding as well as bactericidal and anti-static functions.

Significant disadvantages of all above-mentioned multifunctional layers are their production principle with the functional products or composites to be formulated separately and compatibilities with other existing liquor ingredients that are very often limited.

Another drawback of the production of various multifunctional layers is the multi-stage nature of the method, whereby very cost-intensive process stages such as drying and condensing are to be performed at least twice.

The already-mentioned technical disadvantages also include the washing and performance properties that are very often limited, in particular in the case of functional layers in synthetic fibers and plastics. Since these drawbacks are becoming increasingly important, they are an essential reason for the only gradual acceptance on the market.

The essentially economic drawback lies in the high costs of the individual functional products with their more or less expensive production techniques.

It is the object of the invention to develop a multifunctional principle and production method based on a finish to be applied to solid surfaces, in particular to textiles, which layer inherently fulfills at least two different functions. Examples of such functions are: moisture management, soil release, antistatic, hydrophobicity, hydrophilicity, oleophobicity, controlled-release, conductivity, etc.

Another object consists in the production of high-level requirements on the typical performance properties of the multifunctional layer, whereby the requirement for high washability is common to all multifunctional layers. The properties that are specific to the layer are oriented toward the individual functions to be met by the coating layer.

The object of the invention is achieved by the use of bipolar and/or amphiphilic compounds that are suitable for barrier formation, in particular for membrane formation, in combination with responsive compounds or polymers that are to be switched by a stimulus and that together represent a multifunctional, responsive functional layer.

According to the invention, the property of the multifunctional, responsive functional layer as a total system or at least one of the functions has to be reversibly switchable (responsive) by an external stimulus. The responsive property of the multifunctional, responsive functional layer can be specified by one, several or only by the combination of at least two functional components.

Based on the geometric arrangement of the barrier layer (also referred to as membrane or boundary layer) that is produced by self-assembling [10] and the responsive polymer layer on a solid matrix as well as by the chemical linkage of the barrier layer with the responsive polymer layer, the entire system, i.e., the multifunctional, responsive functional layer, reacts to an external stimulus according to the properties of the responsive polymer.

With the application of different chemical-functional and constitutional compounds for the build-up of multifunctional, responsive functional layers, their geometrically-differentiated arrangement is preferably also provided in the layer. This is accomplished inherently dynamically by self-assembling because of the prevailing interfacial forces, such that, for example, the responsive polymer layer forms on the substrate, or the compound that forms the solid matrix and the membrane or barrier structure or the polymer forms the layer that is oriented toward the air. In this sense, the responsive polymer layer and the barrier layer behave cooperatively relative to their properties.

Chemically-functional compounds have reactive groups, such as, for example, amino, hydroxy, carboxyl, carbonyl, epoxy, and isocyanate groups; constitutional features of the compounds are those that are distinguished by their physical or structural properties, such as, for example, bipolarity, planarity or chirality.

Responsive polymer layers are distinguished in that they show a ‘response’ to an external stimulus (also called trigger). Therefore, the term is also ‘responsive,” whose origin in Latin is ‘respondere=antworten.’ Responsive behavior means that the system change that is triggered by a stimulus is reversible and can be repeated.

The invention is explained in more detail based on the figures. Here:

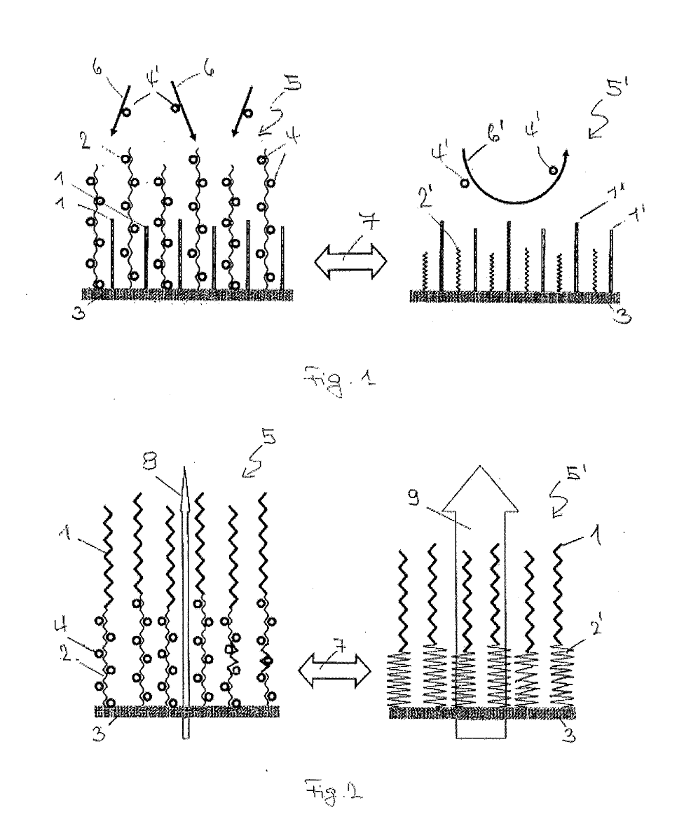

FIG. 1 shows a schematic design of a multifunctional, responsive functional layer with two functional components, of which one can be reversibly switched by an external stimulus.

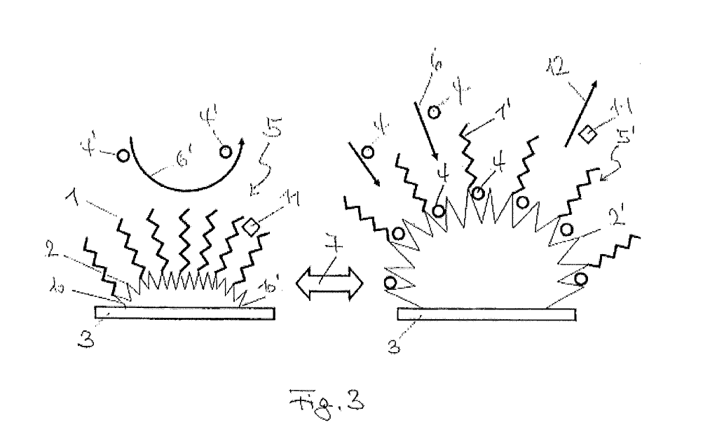

FIG. 2 shows a schematic design of a multifunctional, responsive functional layer with two functional components, whereby the lipophilic functional component rests on the responsive functional component, and temperature forms the external stimulus.

FIG. 3 shows a schematic design of a multifunctional, responsive functional layer with two functional components, whereby the lipophilic functional component rests on the responsive functional component, and the moisture content forms the external stimulus.

FIG. 1 shows the schematic design of a multifunctional, responsive functional layer with two functional components, of which one can be reversibly switched by an external stimulus.

A first functional component 1, which is connected to the substrate 3 by physical-chemical means, is located on a substrate 3 or a solid surface or a solid matrix. In addition to the first functional component 1, there is a second functional component 2, which is also connected to the substrate 3 by physical-chemical means. The second functional component 2 consists of a responsive, polar polymer component on which water molecules 4 are stored. The first functional component 1 consists of a hydrophobizing polymer. First and second functional components 1, 2 form a responsive functional layer 5 or a finishing layer, whose responsive behavior is further explained.

In this functional layer, the responsive and hydrophobizing polymer components 1, 2 exist next to one another in an insulated manner based on the phase separation that is forced to occur during application and attachment. While the hydrophobizing functional component 1 forms, by self-assembling, largely rigid chains for the gas phase (air), the chains of the responsive functional component 2 are greatly stretched with increasing water content, by which a hydrophilic layer dominance of the responsive functional layer 5 results. Water molecules 4′ that are in the gas phase are stored on the responsive functional component 2, which is indicated with an arrow 6. This hydrophilic layer dominance exists at a normal temperature.

An increasing temperature produces increasing dehydration and deflation of the responsive functional components 2′ or the responsive polymer, whereby the stretched chains collapse or ball up. The formerly bonded water molecules 4 evaporate, and a new influx of water molecules 4′ is considerably impeded, which is indicated with the arrow 6′. In addition to the hydrophobizing functional components 1′, the responsive functional component 2′ is retracted, by which now the largely rigid chains of the functional component 1′ or the hydrophobizing polymer dominate the surface of the functional layer 5′.

The external stimulus is the temperature at which the hydrophilicity or the hydrophobicity of the surface of the functional layer 5, 5′ can be reversibly switched. This is indicated with a double arrow 7.

In addition, the barrier or the barrier layer is described. Bipolar monomers and polymer compounds are able to form interfacial structures, in particular membrane layers, starting from micelles and/or vesicles by self-assembling on solid or liquid surfaces. Depending on the polarity of the surface (hydrophilic or hydrophobic), on which the micelle or the vesicle spreads, the thermodynamically-induced self-assembling results in a (hydrophobic or hydrophilic) orientation that is directed vice versa relative to the air [11], [12], [13].

After the application on a solid matrix, for example, bipolar compounds emulsified in water and amphiphilic polymers show a property that is comparable to the micelles or vesicles. Typical examples of such compounds are specially-formulated fat-modified (C₃-C₂₄, preferably C₈-C₁₈) formaldehyde, polyacrylate and polyurethane resins as well as fluorocarbon resins (C₂-C₁₂, preferably C₄-C₈), on whose backbone, for example, acrylate or methane is also based. Additional possibilities are the use of metal salts of higher fatty acids (C₃-C₂₄, preferably C₈-C₁₈), and, for example, fatty acids (C₃-C₂₄, preferably C₈-C₁₈) that are esterified with compounds containing polysaccharides or quat groups.

Block polymers that contain both hydrophobic and hydrophilic segments represent another amphiphilic compound class. The hydrophobic segments are widely based on silicon and fluorocarbon resin, which is based on hydrophilically-preferred polyoxyethylene and polyoxypropylene. The amounts used of the above-mentioned compounds on textiles are 0.1-5%, preferably 0.2-2.0%, of the active substance, relative to the dry weight of the textile material that is to be finished. The above-mentioned compound classes are partially used for hydrophobization of textile fiber materials and fabrics. The barrier layers that are developed by self-assembling with such compounds produced on fabric surfaces for the most part meet only a finishing-specific function, namely a hydrophilization or hydrophobization of the textile material. By the attaching of the compound forming bipolar barriers (monomers and/or polymers) on solid or liquid surfaces, their possible orientation is limited by the rigidity of the molecule chains to be oriented and their proximity to the solid matrix. This in turn reduces the effect.

This drawback is considerably improved by the incorporation of, e.g., spacers between the solid matrix and the barrier layer. Such barrier layers, in particular membrane layers with ‘spacers’ to the solid matrix, are referred to as ‘tethered membranes’ [11], [12].

According to the invention, responsive polymers are used as spacers that can be reversibly switched by external stimuli between differently formed polymer states (e.g., the stretched or balled-up form of the polymer).

Corresponding triggers that set off the switching process, described in the literature, are physical and/or chemical layer-extrinsic factors such as temperature, pH, electrical charge and humidity. As other stimuli that set off the switching process, the ionic strength of an electrolyte solution or that of the polymer surface itself can be named [4], [12], [13].

Depending on design and the object to be achieved, the responsive functional layers according to the invention can be switched by mechanical forces in the range of 10⁻⁷ newton (N) up to several newton (N), as well as by electromagnetic waves (electromagnetic radiation) of the most varied spectral ranges and intensity. As examples, the light of a specific wave range and its intensity can be mentioned.

The above-mentioned factors can occur during use of the materials that are finished with responsive functional layers, such as, e.g., washing, storing, ironing, drying, cleaning, etc. Other extrinsic stimulus-inducing situations are stress (blood pressure, perspiration, etc.), high temperatures, oil and chemical contact.

At the same time, additional functionalities can be generated by the incorporation of a spacer layer. For example, one water-storing device between the solid matrix and the barrier layer that is, for example, hydrophobically dominated, or one anti-static and/or microbial function are very essential.

Examples of responsive polymers are polyethylene oxide and polypropylene oxide derivatives as well as their copolymerizates, ethoxylated and propoxylated polysaccharides, polyacrylamides or polyacrylates as well as polyelectrolytes, such as, e.g., ionic polysaccharides, acrylamides or acrylates.

The amounts used in this connection are 0.05-5.0%, preferably 0.1-2.0% of the active substance, relative to the dry weight of the textile material that is to be finished.

In addition to the preferred one-stage procedure for the production of multifunctional, responsive functional layers according to the principle of the invention, a two-stage or multi-stage production method [14], [15] is also practicable in the acceptance of additional charges. Such a procedure is applied, for example, during the incorporation of a bi-layer structure for producing a high-level reversible water storage capacity to thereby achieve a high degree of heat regulation.

In such a case, first the responsive spacer layer is applied by an impregnating process, while the barrier-forming functional component or the functional composite is then applied on one side or two sides. As one-sided application techniques, e.g., splashing, spraying, and knife-coating are available, while two-sided application is preferably carried out by dipping.

The one-sided or two-sided barrier-layer application is oriented for the purpose of the textile material. In the case of one-sided barrier-layer application, the fabric side that is opposite the barrier layer is hydrophilic and is able to take up water as a liquid phase. In a two-sided barrier layer application, the water transport is carried out in the hydrophilically responsive functional layer primarily via the gas phase.

FIG. 2 shows the schematic design of a multifunctional, responsive functional layer with two functional components, whereby the lipophilic functional component rests on the responsive functional component and temperature forms the external stimulus.

The second functional component 2, which is connected to the substrate 3 by physical-chemical means and consists of a responsive, polar polymer component, on which water molecules 4 are stored, is located on the substrate 3. Here, the first functional component 1, namely a lipophilic component, is attached to the responsive polymer component by physical-chemical means. The second functional component 2 is also referred to as a spacer polymer.

First and second functional components 1, 2 form a responsive functional layer 5 or a finishing layer.

If the substrate 3 is an article of clothing or a fabric, the responsive functional layer 5 located thereon at normal temperature (no physical exertion) allows only a small transport of water, which is indicated with a narrow arrow 8. In the case of physical exertion and the associated temperature increase, the responsive functional layer 5′ allows an excellent transport of water, which is indicated with a wide arrow 9.

The external stimulus is temperature, with which the hydrophilicity or the hydrophobicity of the surface of the functional layer 5, 5′ can be reversibly switched or triggered. This is in turn indicated with the double arrow 7.

The functional layer 5 can also contain several first functional components 1 and several second functional components 2. It is in no way limited to an individual first and second functional component.

By the one-stage application of bipolar, barrier-forming compounds with responsive polymer compounds as spacers on textiles, functional layers for moisture transport and for heat regulation of textiles that are applied next to the body are produced according to the invention. The responsive polymer layer has the property of a water-storing device, whose storage capacity is determined by the temperature. By the use of responsive spacer polymers, the properties that are typical of this layer can be switched on or off. Especially important in this case is the temperature as a trigger, which—when using responsive polymers in this connection—results in the hydration or dehydration thereof. In the corresponding switching, the responsive polymer layer shows a clear and reversible change in the chain arrangement, which can vary from the stretched form to the form that is completely balled-up.

According to this example, the use of a responsive polymer that binds to water at lower body temperatures (<30° C.) and precipitates water at higher temperatures because of increasing insolubility [16] is advantageous. Since the released water more or less quickly evaporates corresponding to the prevailing conditions and energy is removed by the evaporation enthalpy that is to be applied to the system, a cooling of the textile and thus the skin is the result.

The functional layers that are produced on two sides in this way show outwardly a hydrophobically dominated and thus dry behavior, e.g., on the skin in the case of textiles that are applied close to the body. The water that is released from the body by perspiration is primarily transported via the gas phase into the spacer layer, stored, and, depending on temperature conditions, released very quickly to the environment without a noticeable feel of moisture on the skin.

By variation of the mass ratios between the hydrophobically dominated barrier polymer and the hydrophilically dominated responsive polymer in the dispersion/emulsion applied on a solid matrix, a gap in mixing can result by removal of the homogeneous phase (e.g., water) during the layer attachment. Such gaps in mixing can also be formed by other stimuli, such as, e.g., electrical charges or electrolytes. Because of the mixing gaps that occur, the polar-dominated amphiphilic polymer forms water-transporting polymer bridges, comparable to the transmembrane proteins in biological membranes.

Another special feature of this functional layer according to the invention is the hydrophobicity that dominates in the low to average relative air humidity (≦80%), which means an extreme water-repellent property, and the hydrophilicity that increases at higher relative humidity (>80%), which means an excellent washability of dirt. By the incorporation of micro- and/or nanoparticles in the functional layer or in the composite, responsive self-cleaning surfaces can be produced.

Both in the described application and in the following application, lotus-effect layers [17] and petal-effect layers [18] are inherently present, whereby the humidity or the corresponding water content of the functional layer is the trigger for switching the respective function. Soil-release functional layers, based on this principle, show high effect levels.

Another application of this principle is that of a water collector. In this case, for example, the hydrophilically-dominated responsive polymer is immobilized on several μm size particles (e.g., SiO₂) and dispersed into water together with the hydrophobic membrane polymer and corresponding dispersing agents. By the drying that is carried out after the application, a phase separation occurs with the formation of hydrophilic condensation nuclei. The latter are able to sorb water from the gas phase with decreasing ambient temperature on one side (top side) of the textile material and to transport to the rear side as a liquid phase by the bridges that are present because of the phase separation from polar polymer associates or also to allow flow-off on the top side of the fabric. Here, it results in drop formation and can be further used, for example, as drinking water. With increasing temperature, the responsive polymer is again dehydrated, with the degeneration of the hydrophobic domain. Sample applications are camping, watering of crops, and use as military survival equipment.

FIG. 3 shows the schematic design of a multifunctional, responsive functional layer with two functional components, whereby the lipophilic functional component rests on the responsive functional component, and the moisture content forms the external stimulus.

The second functional component 2, which is connected to the substrate 3 by physical-chemical means only at the two points 10, 10′, is located on the substrate 3. The second functional component 2 consists of a responsive, polar polymer component as a spacer layer. Here, the first functional component 1, namely a hydrophilic component, is attached to the responsive polymer component by physical-chemical means. First and second functional components 1, 2 form a responsive functional layer 5 or a finishing layer, e.g., a soil-release functional layer.

The responsive functional layer 5 is water-repellent at a low moisture content, which is indicated with the water molecule 4′ and with the arrow 6′. Any contamination 11 or dirt particles adhere to the hydrophobic surface of the functional layer 5.

A swelling or stretching of the spacer polymer 2′ occurs by the water absorption of the responsive polymer and the pH that is preferably adjusted to be weakly alkaline. Consequently, the distance of the first functional component 1′ or the hydrophobic chains attached thereto opens up. As a result, the influx of water is made possible, which is indicated with the water molecule 4 and with the arrow 6. As a result, the purification effect of the functional layer 5′ and thus the substrate 3 from any contamination 11 is made possible, which is indicated with an arrow 12.

The external stimulus is the moisture content of the functional layer 5, 5′, which can be reversibly switched or triggered with the washing process or the drying. This is in turn indicated with the double arrow 7.

The ‘soil-release’ function is composed of two opposite functions. On the one hand, this is the dirt-shedding function, and, on the other hand, this is the best possible washability of once-contaminated surfaces. The principle for implementing the two functions consists in the application of a hydrophobic membrane-forming polymer in combination with a hydrophilically-dominated responsive polymer. By the application of specially modified cellulose derivatives as spacer-polymers, the latter is present with low humidity in balled-up, more or less unswollen form. In the presence of water, for example during the washing process, an influx of water can be detected by existing flaws in the barrier layer, which has the result of a considerable swelling of the spacer layer and thus also an opening of the membrane layer. As a trigger for inducing the responsive effect, in this case the increased water content of the spacer layer is used.

The spacer layer is not necessarily a responsive polymer layer; thus, at least a first functional component can also be designed as a spacer layer, for example as a lipophilic functional component.

As polymers that form barrier layers, preferably fluorocarbon resins with C₄-C₁₂ chains are used, and as responsive polymers, polyelectrolytes, such as, e.g., carboxylated polysaccharides and/or acrylic acid derivatives, are used. The amount of barrier-layer-forming compounds used is 0.1-3.0%, preferably 0.2-1.5%, and that of the responsive polymer is 0.05-5.0%, preferably 0.1-2.0%, of the active ingredient, relative to the dry weight of the textile material that is to be finished.

The responsive property of a corresponding spacer-polymer can also be used to achieve a high level of oil and gasoline shedding from, e.g., protective clothing. The high level of oil and gasoline shedding in the case of protective suits for the police, firefighters and military has special importance since in the case of corresponding uses, the risk of fire is the greatest threat. While oil or gasoline that has penetrated the unswollen spacer-polymer once can be distributed in an unimpeded manner, the swollen spacer polymer forms a second barrier layer that is impermeable to oil and gasoline. The swelling of the responsive spacer layer is already carried out by human perspiration, by which in this case, the relative air humidity of the climate that is close to the body is the stimulus for the creation of the desired function. This behavior can be repeated as often as desired after a protective suit is dried.

In addition to the barrier-forming components and the responsive polymer components, a functional layer according to the invention contains additional ingredients and thus forms a multifunctional composite.

Cross-linking agents: As cross-linking agents, formaldehyde resins, in particular melamine and ethylene urea derivatives, such as, e.g., Knittex FEL (Huntsman), free and blocked isocyanates, such as, e.g., phobol XAN (Huntsman), aziridine compounds, such as, e.g., XAMA 7 (flevo chemistry) and multifunctional glycidyl compounds, such as, e.g., Isobond GE 100 (Isochem) are used. The amounts used, depending on mass, vary as a function of molecular weight and reaction group content of the cross-linking agent in the range of 0.05-1.5%, preferably 0.1-0.5%, of the active substance, relative to the dry weight of the textile material that is to be finished.

Catalysts: The catalysts are to be selected specific to the reaction system. In the case of formaldehyde resins, but also when using glycidyl compounds, metal salts and preferably carboxylic acids are used. Typical catalysts for formaldehyde resins are magnesium chloride, aluminum chlorohydrate, citric acid, and tartaric acid. The amounts of metal salts used in the liquor are 1-25 g/l, preferably 5-15 g/l. The acid concentrations that are to be adjusted in the liquors are in the range of 0.1-10 g/l, preferably 0.5-4 g/l.

When using isocyanates but also amines attained from glycidyl compounds, preferably tertiary amines, such as, e.g., 1,4-diazabicyclo(2,2,2)octane (DABCO), triethanolamine, 1,2-dimethylimidazole and benzyldimethylamine (BDMA), are used. The amounts used are 0.5-15 g/l, preferably 2-10 g/1.

With the thus described measures, a new generation of finishing methods is created, which leads to improved humidity and temperature control by textiles applied close to the body corresponding to the underlying bionic design.

### EXAMPLE 1

### Soil-Release Functional Layer

This example relates to the production of a soil-release function in textiles, with a functional component with a responsive action, characterized by a shedding of hydrophilic and hydrophobic substances as well as by a simultaneously present good washability of any dirt residues.

For the production of dirt-shedding shirts, a soil-release liquor formulation is applied to a thread of colored blended fabric with a square meter weight of 120 g, consisting of 70% polyester and 30% cotton. In this case, this is a responsive functional layer, which is shedding water and oil, on the one hand, and can be purified within the scope of a washing process on the other hand. The stimulus for switching the respective function (shedding or mobilizing) is the moisture content of the functional layer. While the latter has a high level of water, oil and dirt shedding up to a moisture content of approximately 8% relative to the dry weight of the finishing layer, a great reduction of the shedding nature occurs with additional increase of the water content (typically in the washing machine). With the reduction of water, oil and dirt shedding, the hydrophilic nature of the functional layer increasingly dominates, by which the removal of dirt is essentially simplified. The subsequent drying of the article of clothing in turn leads to the original condition, with the high level of water, oil and dirt shedding. The production of the functional layer is carried out by the application of a liquor that contains all functional components. The latter is applied to the fabric by means of an impregnation process with a pick-up of 65%. The functional layer is attached to the fabric in a wash-proof manner by the subsequent drying of the fabric at approximately 120° C. and condensation at 150° C. The liquor formulation is cited in Table 1.

TABLE 1
Liquor Formulation

| | | | Concentration |
|---|---|---|---|
| Liquor Component | Function | Company | g/l |
| Soft Primer LFM | Adhesive | Soft Chemicals | 10 |
| Knittex FEL | Formaldehyde Resin | Huntsman | 15 |
| Magnesium | Catalyst | Fluka | 7 |
| Chloride | | | |
| Citric Acid | Catalyst | Fluka | 1 |
| Oleophobol 7752 | Fluorocarbon Resin | Huntsman | 37 |
| Respond B | Responsive Polymer | HeiQ | 12 |
| | Composite | | |
| Isopropanol | Wetting Agent | Fluka | 10 |

The fabrics that are finished according to the described methods show a very good level of water, oil and dirt shedding, characterized by the contact angle with water and heptane (Tab. 2), as well as by the evaluation of the dirt removal after a washing operation at 40° C. (Tab. 3).

TABLE 2
Characterization of Water and Oil Shedding

| | | | Contact Angle after 10 | |
|---|---|---|---|---|
| | Unwashed Contact Angle | | Washing Cycles | |
| Fabric Moisture | Water | Heptane | Water | Heptane |
| <8% | 143° | 71° | 138° | 68° |
| >15% | 63° | <0% | 62° | ≦0 |

TABLE 3
Evaluation of the Dirt Removal

| | Purification | | | |
|---|---|---|---|---|
| Contamination | Water at 20° C. | | Washing Process at 40° C. | |
| With: | Original | Washed 10× | Original | Washed 10× |
| Soot | 5 | 4 | 5 | 5 |
| Suspension | | | | |
| Mustard | 4 | 4 | 5 | 5 |
| Emulsion | | | | |
| Ketchup | 5 | 4 | 5 | 5 |
| Blood | 4 | 4 | 5 | 5 |
| Salad Dressing | 5 | 4 | 5 | 5 |
| Coffee at 60° C. | 4 | 4 | 5 | 5 |
| Balsamic | 5 | 5 | 5 | 5 |
| Vinegar | | | | |

The rating scale comprises Grades 1-5. Grade 1 corresponds to an invisible purification effect, and Grade 5 means complete removability. Grade 4 is tantamount to hardly visible residues (dirt removal>95%).

Based on the values in Tables 2 and 3, the very good level of water, oil and dirt shedding in the dry fabric state and the good possible purification of fabric by the responsive functional behavior as well as the washability of the functional layer in the wet state of the fabric are demonstrated according to the invention.

### EXAMPLE 2

### Combination of the Soil-Release Function with an Anti-Microbial Function

This example relates to the production of a multifunctional responsive functional layer, which combines an anti-microbial action with a hydrophilic or hydrophobic function, whereby the anti-microbial function can be switched on and off by an external stimulus.

To meet the high functional standard of work clothing in the health-care sector (hospital, doctor's offices, etc.), the corresponding textile material has to be finished with a combined soil-release/anti-microbial function. This is a polyester fabric with a square meter weight of 160 g.

The production of the functional layer is carried out in two stages. In the first application process, the responsive and anti-microbial functional composite is applied (Tab. 4), and in the second step, the application of the membrane layer is carried out. The introduction of the layer that has a responsive/anti-microbial action is carried out by means of a Foulard process (Tab. 5). The resulting pick-up is 45%, relative to the dry weight of the fabric. The drying process—carried out after padding—is done in such a way that the resulting residual moisture on the fabric after this process step is 20-25%.

In the second step, the membrane layer is also applied with an impregnation process. The pick-up of the liquor that contains the membrane composite is 30%. The subsequent drying is performed at 120° C., followed by the condensation process, with a temperature setting of 150° C.

TABLE 4
Liquor Formulation of the First Application Step (Responsive and
Anti-microbial).

| Liquor Component | Function | Company | Concentration g/l |
|---|---|---|---|
| AGS-20 TF | Silver Particle | HeiQ | 40 g/l |
| | Composite | | |
| Lyofix CHN | Formaldehyde- | Huntsman | 10 g/l |
| | Containing | | |
| | Melamine Resin | | |
| Respond B | Responsive | HeiQ | 37 g/l |
| | Composite | | |
| Magnesium | Catalyst | Fluka | 8 g/l |
| Chloride | | | |
| Citric Acid | Catalyst | Fluka | 1.5 g/l |
| Water | — | — | 893.5 |
| 2-Propanol | Wetting Agent | Fluka | 10 g/l |

TABLE 5
Liquor Formulation of the Second Application Step
(Membrane Formulation)

| Liquor Component | Function | Company | Concentration g/l |
|---|---|---|---|
| HeiQ Barrier | Membrane | HeiQ | 45.0 |
| | Composite | | |
| Phobol XAN | Cross-Linking | Huntsman | 8.0 |
| | Agent | | |
| Water | — | — | 988.0 |

TABLE 6
Characterization of the Water and Oil Shedding

| Water/Isopropanol | Unwashed Contact Angle | Contact Angle Washed 50× |
|---|---|---|
| 100/0% | 142° | 97° |
| 90/10 | 91° | 47° |
| 70/30 | 47° | 19° |
| 50/50 | 32° | 9° |
| 30/70 | 19° | <0° |
| 0/100 | 16° | <0° |

TABLE 7
Evaluation of the Dirt Removal

| | Purification | | | |
|---|---|---|---|---|
| Contamination | Water at 20° C. | | Washing Process at 40° C. | |
| with: | Original | Washed 10× | Original | Washed 10× |
| Soot | 5 | 4 | 5 | 5 |
| Suspension | | | | |
| Mustard | 4 | 4 | 5 | 5 |
| Emulsion | | | | |
| Ketchup | 5 | 4 | 5 | 5 |
| Blood | 4 | 4 | 5 | 5 |
| Salad Dressing | 5 | 4 | 5 | 5 |
| Coffee at 60° C. | 4 | 4 | 5 | 5 |
| Balsamic | 5 | 5 | 5 | 5 |
| Vinegar | | | | |

Because of its responsive functional behavior, the finish that is described shows a washing-resistant, high level of water, oil and dirt shedding in the dry state of the fabric, and the excellent washability of contamination as well as the desired antimicrobial function after fifty washing cycles at 40° C. in the wet state. The good level of possible purification that exists especially in this finish is usually not given in fabrics that are hydrophobized with fluorocarbon resins. The anti-microbial action, which is in the polar, responsive polymer, develops with increasing moisture content. In any case, a bacterial attack is hardly possible when there is little or no water on the functional layer. The layer characterization is done by the determination of the contact angle with water/alcohol solutions in the unwashed state and after 50 washing cycles (Tab. 6) as well as by a soiling test with various substances (Tab. 7).

### EXAMPLE 3

### Moisture Transport and Temperature-Regulating Finish

This example relates to a responsive, finish-based functional layer on textiles; the layer inherently comprises both moisture transport and heat regulation. Modern requirements on modern athletic undergarments also include the anti-microbial function in addition to the pleasant feeling of wearability, which is essentially determined by moisture transport. An additionally desired function is the heat regulation that is now produced via the fiber material and the knitted fabric design as well as, in any case, with the use of phase-change materials (PCM). According to the invention, in this example of finish, the heat-regulating action is achieved by the use of a responsive composite.

A knitted fabric that consists of 80% polyester, 15% cotton, and 5% spandex is impregnated in one stage with a liquor formulation that contains the functional components (Tab. 8). By the application of a composite that has a responsive action whose water-storing function is regulated by the temperature, a permanent heat regulation results in contrast to the phase-change materials.

The liquor application is carried out by means of a Foulard passage with subsequent squeezing, drying of the fabric, and condensation for washing-permanent attachment of the functional layer to the textile material. The application of liquor is 72%. The drying is performed at 110-120° C., and the condensation is performed at 150-160° C.

The criteria for evaluating the functions are the contact angle with water, the antimicrobial action, and the water storage by the responsive composite with the associated release of water. The layer characterization is done in the unwashed state as well as after 10 washing cycles, which were performed at 40° C. (Tab. 9). The liquor formulation is cited below.

TABLE 8
Liquor Formulation

| | | | Concentration |
|---|---|---|---|
| Liquor Component | Function | Company | g/l |
| Soft Primer LFM | Adhesive | Soft Chemicals | 10 |
| Knittex FEL | Formaldehyde Resin | Huntsman | 17 |
| Magnesium | Catalyst | Fluka | 7 |
| Chloride | | | |
| Citric Acid | Catalyst | Fluka | 1 |
| Softgard A | Fluorocarbon Resin | Soft Chemicals | 37 |
| Respond H | Responsive Polymer | HeiQ | 12 |
| | Composite | | |
| Isopropanol | Wetting Agent | Fluka | 10 |
| Water | — | — | |

TABLE 9
Characterization of the Functional Layer in the Unwashed
State and After 10 Washing Cycles.

| Criteria | Unwashed | Washed 10× (40° C.) |
|---|---|---|
| Contact Angle with Water | 105° | 97° |
| Bactericidal Test ⁽¹⁾ | ≧3.0 | ≧3.0 |
| Water Storage at 20° C. | 22% | 26% |
| Water Storage at 35° C. | 8% | 11% |

⁽¹⁾ Test Method: Japanese Industrial Standard JIS L 1902

The values of Table 9 clearly show the water storage capacity of the responsive functional layer that decreases with increasing temperature and the associated increasing water evaporation that removes heat from the system. According to the invention, this can be attributed to the responsive behavior of the functional layer. This is a direct result of the dehydration of the responsive polymer that occurs in the case of elevated body temperature.

The bacterial test shows that a permanently high level of anti-microbial function is present and thus odor does not form even with heavy perspiration.

The contact angle with water is above 90°, wherein the formation of a wet layer on the body side of the textile is ruled out, but the water transport via the gas phase is possible in an unimpeded way. By the combination of the three functions (moisture transport, heat regulation, anti-microbial effect), an extremely pleasant feeling of wearability is also imparted even in the case of changing wear conditions on the body.

### EXAMPLE 4

### Body-Temperature-Regulating Finish of Athletic Clothing

With this example, a responsive finishing layer on textiles, in particular for athletic clothing, is described. It is used in the regulation of body temperature based on water sorption and desorption. With the water desorption from the functional layer, the evaporation rate is increased, which can lead to heat being removed from the body. The external stimuli for the responsive behavior of the functional layer are the temperature and the electrolyte content of the water (perspiration) that is released from the body. While under normal stress, the perspiration released from the body is first and foremost transported as water vapor and is partially sorbed by the finishing layer; in the case of athletic activity, a mixed phase that consists of perspiration liquid and water vapor occurs. Both the increased temperature (approximately 30° C.) and the electrolyte content of the perspiration liquid result in the contraction and crinkling of the responsive polymer with the associated ‘release’ of the sorbed water.

The polymers that are used for this purpose are, on the one hand, block- or statistical polymers based on polyethylene oxide, which have additional anionic end groups and, on the other hand, product mixtures, whereby one of the products is non-ionogenic in nature and the other is ionogenic (anionic or cationic) in nature.

A fabric that consists of 92% polyester and 8% spandex is impregnated with a liquor that contains the functional polymers (Tab. 10). The presence of the functional polymer(s) (62% nonionogenic, 38% anionic relative to the total polymer mass) in the finish layer results in the regulation of the body temperature, whereby a cooling action is carried out by the elevated water release starting at approximately 28° C. The liquor application and the completion of the finish is carried out with a conventional technique (impregnation, drying, and condensing). The liquor application is 48% relative to the dry weight of the fabric.

The drying is performed at 100-120° C., and the attachment of the finishing layer on the textile substrate is performed at 150-160° C.

The characterization of the functional layer is done by the detection of the water sorption at varying temperature and varying electrolyte content of the water.

The liquor formulation and test results are cited in Tables 10 and 11.

TABLE 10
Liquor Formulation

| Liquor Component | Function | Company | Concentration g/l |
|---|---|---|---|
| Respond I | Responsive Polymer | HeiQ | 75 |
| Phobol XAN | Cross-Linking Agent | ERBA | 8 |
| Fumexol WDN | Wetting Agent | ERBA | 1 |
| Prodotto 175 | Fluorocarbon Resin | HeiQ | 10 |
| Acetic Acid | pH Adjustment | Fluka | 1 |

TABLE 11
Characterization Results of the Functional Layer

| | | | g of H₂O/g |
|---|---|---|---|
| | | Unwashed g | of TS⁽²⁾ |
| | | of H₂O/g of | Washed 5× |
| Water Sorption⁽¹⁾ | Temperature ° C. | TS⁽²⁾ | at 40° C. |
| Deionized Water | 25 | 11.70 | 7.30 |
| Deionized Water | 40 | 0.63 | 1.12 |
| 1% Common Salt Solution | 25 | 13.41 | 9.12 |
| 1% Common Salt Solution | 40 | 0.44 | 0.95 |

⁽¹⁾The water sorption was determined with the percolation method (O. Marte, U. Meyer, Neue Testverfahren zur Bewertung hydrophober and superhydrophober Ausrüstungen [New Test Methods for Evaluating Hydrophobic and Superhydrophobic Finishes], Melliand Textilberichte [Melliand Textile Reports] October 2006)
⁽²⁾TS: = Dry substance of the finishing layer

The test results that are cited in Table 11 show the high level of water absorption of the finishing layer at 25° C. and the clearly lower water absorption at 40° C. in comparison to 25° C. This effect (release of the water that was formerly sorbed), in combination with the water evaporation, is responsible for the cooling action of the described finish on athletic clothing. A comparison of the sorption values with pure water and each with a physiological common salt solution show that water sorption and release can be increased by electrolytes and thus the cooling action can be intensified.

The cited examples are diverse and are in no way exhaustive.

Thus, the achievement of a heavier oil shedding in comparison to modern finishes that shed water and oil based on fluorocarbon resin is carried out by the use of a component that acts responsively on the entire system, which is also coupled to an anti-microbial finish.

In addition, the shedding of liquid dirt and/or dirt that is present as an aerosol can be done with simultaneous absorption of penetrated odors into the substrate in gaseous form, as well as the ability to wash them out again, based on the responsive action of the entire system, or the production of a multifunctional, responsive functional layer, which combines an anti-static action with a hydrophilic or hydrophobic function, whereby the anti-static function can be switched on and off by an external stimulus.

The responsive functional layers according to the invention are used:

In work and protective clothing, such as, e.g., in the hospital, in the fire department, police, military, forestry service offices and in food technology.

In addition for sportswear, e.g., outdoor clothing such as jackets, pants, head coverings, and as articles of clothing such as shirts, pants and sneakers that are applied in a breathable manner next to the skin.

Also, as undergarments, e.g., thermal undergarments with an additional anti-microbial effect.

Other uses are cloths, tablecloths, tent tarps, films, bed linens, or a use as a water collector.

1. Multifunctional responsive functional layer on a substrate, comprising:
at least a first functional component;
at least a second functional component having a chemical-functional and constitutional specification for a responsive behavior or a responsive property to be reversibly switchable by an external stimulus, the first and second functional components being distinguished in their inherently provided properties, and being selected to behave cooperatively relative to their properties in the functional layer; and
physical-chemical means for connecting at least one of the first and second functional components to the substrate.

2. Functional layer according to claim 1, wherein the responsive property of the functional layer is provided by a combination of at least the first and the second functional components.

3. Functional layer according to claim 1, wherein at least one of the first functional components and one of the second functional components are designed as a spacer layer.

4. Functional layer according to claim 1, wherein the first and second functional components are beside one another on the substrate and wherein a mixing gap is produced by removal of water, which leads to formation of water-transporting polymer bridges.

5. Functional layer according to claim 1, configured to be switchable by mechanical forces in a range of 10⁻⁷ Newton up to several Newton by electromagnetic radiation of varied spectral ranges and intensity.

6. Functional layer according to claim 1, configured to be switchable by physical and/or chemical, layer-extrinsic factors including temperature, pH, electrical charge, humidity, ion intensity of an electrolyte solution or polymer surface.

7. Functional layer according to claim 1, wherein the external stimulus is stress, temperature, oil and chemical contact.

8. Functional layer according to claim 1, wherein the second functional component with the responsive property is connected as a spacer layer to the substrate by the physical-chemical means, and wherein on the second functional component, the first functional component is attached as a hydrophobic barrier layer by the physical-chemical means, by which the functional layer forms a water-storing device between the substrate and the first functional component.

9. Functional layer according to claim 1, wherein at least one second functional component is a responsive polymer from a group of polyethylene oxide and polypropylene oxide derivatives as well as their copolymerizates or from the group of ethoxylated and propoxylated polysaccharides, polyacrylamides, or polyacrylates, polyelectrolytes.

10. Functional layer according to claim 9, wherein an amount of responsive polymer is 0.05-5.0 of an active substance, relative to a dry weight of a textile material that is to be finished.

11. Functional layer according to claim 1, comprising:
a lotus-effect or a petal-effect layer by incorporation of nano- and/or microparticles in the functional layer, whereby humidity or corresponding water content of the functional layer forms a trigger for switching on the respective function or property.

12. Functional layer according to claim 1, possessing a switchable function of moisture transport, heat transport, soil release, hydrophobicity, oleophobicity, or a combination thereof.

13. Functional layer according to claim 1, wherein the second functional component possesses an antistatic effect or an anti-microbial effect.

14. The functional layer according to claim 1 in combination with work or with protective clothing.

15. The functional layer according to claim 1 in combination with athletic clothing, outdoor clothing, or undergarments.

16. The functional layer according to claim 1, configured as a water collector.

17. Method for producing, on a substrate, a multifunctional, responsive functional layer containing:
at least a first functional component;
at least a second functional component having a chemical-functional and constitutional specification for a responsive behavior or a responsive property to be reversibly switchable by an external stimulus, the first and second functional components being distinguished in their inherently provided properties, and being selected to behave cooperatively relative to their properties in the functional layer; and
physical-chemical means for connecting at least one of the first and second functional components to the substrate;
the method comprising:
introducing the at least first and second functional components into a single liquor; and
applying the first and second functional components to the substrate, wherein the substrate is run into a drying unit, where a design of the functional layer is carried out, the functional layer being attached to the substrate by physical-chemical means to produce a responsive functional layer in a one-stage process.

18. Method for producing, on a substrate, a multifunctional, responsive functional layer containing:
at least a first functional component;
at least a second functional component having a chemical-functional and constitutional specification for a responsive behavior or a responsive property to be reversibly switchable by an external stimulus, the first and second functional components being distinguished in their inherently provided properties, and being selected to behave cooperatively relative to their properties in the functional layer; and
physical-chemical means for connecting at least one of the first and second functional components to the substrate;
the method comprising:
applying the second functional component on two sides on the substrate to form a responsive spacer layer; and
applying the first functional component on the two sides, wherein the substrate is impacted in two stages and run into a drying unit, where a design of the functional layer is carried out, the functional layer being attached to the substrate by the physical-chemical means to produce a responsive functional layer on both sides of the substrate in a two-stage process.

19. Method for producing, on a substrate, a multifunctional, responsive functional layer containing:
at least a first functional component;
at least a second functional component having a chemical-functional and constitutional specification for a responsive behavior or a responsive property to be reversibly switchable by an external stimulus, the first and second functional components being distinguished in their inherently provided properties, and being selected to behave cooperatively relative to their properties in the functional layer; and
physical-chemical means for connecting at least one of the first and second functional components to the substrate;
the method comprising:
applying the second functional component on two sides to the substrate to form a responsive spacer layer; and
applying the first functional component on only one side, wherein the substrate that is impacted in two stages is run into a drying unit, where a design of the responsive functional layer is carried out, the functional layer being attached to the substrate by physical-chemical means to produce a responsive functional layer only on one side of the substrate in a two-stage process.

20. Method according to claim 17, comprising:
adding cross-linking agents and/or catalysts to the first and second functional components, by which a multifunctional composite is formed.
